(19) United States
(12) Patent Application Publication
(10) Pub. No.: US 2010/0059160 A1
(43) Pub. Date: Mar. 11, 2010

(54) CARBON BLACK REINFORCED RUBBER COMPOSITION WITH AROMATIC GUANIDINE ANTIOZONANT AND TIRE HAVING COMPONENT THEREOF

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/206,094

(22) Filed: Sep. 8, 2008

(51) Int. Cl. C08K 5/31

(52) U.S. Cl. 152/525; 524/195

(57) ABSTRACT

This invention relates to a carbon black reinforced rubber composition with aromatic guanidine antiozonant. The invention particularly relates to a sulfur curable rubber composition which contains a primary sulfenamide sulfur vulcanization accelerator and an antiozonant as a combination of amine antiozonant and a sufficient amount of secondary aromatic guanidine sulfur vulcanization accelerator to require a sulfur vulcanization retarder. Representative of such aromatic guanidine sulfur vulcanization compounds are diphenyl guanidine and di-ortho-tolyl guanidine. The invention further relates to rubber products, including tires, particularly tire sidewalls, comprised of such rubber composition, which are intended to have exposure to atmospheric ozone.

### FIELD OF THE INVENTION

This invention relates to a carbon black reinforced rubber composition with aromatic guanidine antiozonant. The invention particularly relates to a sulfur curable rubber composition which contains a primary sulfenamide sulfur vulcanization accelerator and an antiozonant as a combination of amine antiozonant and a sufficient amount of secondary aromatic guanidine sulfur vulcanization accelerator to require a sulfur vulcanization retarder. Representative of such aromatic guanidine sulfur vulcanization compounds are diphenyl guanidine and di-ortho-tolyl guanidine. The invention further relates to rubber products, including tires, particularly tire sidewalls, comprised of such rubber composition, which are intended to have exposure to atmospheric ozone.

### BACKGROUND OF THE INVENTION

Various products contain rubber components which are composed of sulfur curable, conjugated diene-based (derived from conjugated dienes) elastomers which are exposed to ozone, namely ozone-containing atmosphere, and are thereby subject to surface degradation by exposure to atmospheric ozone.

To retard, or resist, such ozone surface degradation, the rubber composition of such components typically contains an antiozonant contained within the rubber composition, such as for example an amine-based antiozonant, a practice well known to those having skill in such art.

Historically, the rubber composition of such component which contains one or more conjugated diene-based elastomers are typically subject to such ozone surface degradation, particularly as a result of their inherent carbon-to-carbon double bond content which is typically attackable by atmospheric ozone unless the rubber composition contains an antiozonant.

In practice, the rubber composition is typically sulfur vulcanized by a sulfur cure package comprised of a combination of sulfur and at least one sulfur cure accelerator, namely a primary sulfur cure accelerator and, if required in order to increase a slow sulfur cure rate of the rubber composition, a combination of sulfur cure accelerators composed of a primary sulfur cure accelerator and a more active secondary sulfur cure accelerator normally used in minor amounts because it is not normally desired to increase the sulfur cure rate excessively. Accordingly, where the cure rate of a rubber composition is somewhat sluggish and too slow to be practically useable in a production circumstance, a small amount of a faster sulfur cure rate promoter is added to the cure package, which is usually referred to as a secondary sulfur cure accelerator, to speed up the rate of cure of the rubber composition, a practice well known by those having skill in such art.

Representative of such primary sulfur cure accelerators are, for example, sulfenamides which are well known to those having skill in such art.

Representative of such optional secondary sulfur cure accelerators is, for example, an aromatic guanidine, representative of which are diphenyl guanidine and di-ortho-tolyl guanidine, of which the diphenyl guanidine is the most commonly used secondary sulfur cure accelerator when it is appropriate to use a secondary sulfur cure accelerator to increase the sulfur cure rate of the rubber composition.

As compared to carbon black reinforced rubber compositions, silica reinforcement containing rubber compositions typically require a greater amount of diphenyl guanidine secondary accelerator with the sulfenamide primary accelerator than a solely carbon black reinforced rubber composition as is hereinafter discussed.

However, by an accidental experiment, it was discovered that, for a carbon black reinforced rubber composition containing conjugated diene-based elastomer(s) without the presence of silica reinforcement, when a sufficient excessive amount of such aromatic guanidine secondary accelerator is used in combination with a sulfenamide primary accelerator that the sulfur cure rate of the rubber composition is excessively high to an extent that addition of a sulfur cure retarder is necessary to retard the sulfur cure rate of the rubber composition, the rubber composition can exhibit a significant increase in resistance to rubber surface degradation due to exposure to ozone.

It is considered herein that such excessive addition of the aromatic guanidine secondary accelerator is beyond conventional logic for the carbon black-reinforced rubber composition. Conventional logic would seem to simply add less of the aromatic guanidine secondary accelerator to reduce the sulfur cure rate of the carbon black reinforced rubber composition to a more suitable level.

Therefore, it is considered that such discovery is thereby beyond conventional practice for carbon black reinforcement-based sulfur curable rubber-containing compositions.

It has further been observed herein that such enhanced ozone resistance can extend well beyond ozone resistance attributed to the presence of only an amine-based antiozonant compound in the rubber composition. Indeed, an apparent synergistic antiozonant effect has been observed by using a combination of such excess of aromatic guandine sulfur cure accelerator (that a sulfur vulcanization retarder needs to be added to appropriately slow the sulfur cure rate of the rubber composition) and amine based antiozonant.

It is important to appreciate that an increase in diphenyl guanidine secondary accelerator is often used for a silica reinforcement-containing rubber composition as compared to a carbon black reinforced rubber composition.

This is because, silica, such as for example precipitated silica, interferes with the secondary accelerator effect, probably because of a silica absorbing effect for the diphenyl guanidine, in a manner not observed with carbon black reinforcement, so that, in order to achieve a suitable sulfur cure rate, relatively more diphenyl guanidine is necessarily used for the silica reinforced rubber composition.

Use of such excessive amount of the diphenyl guanidine in a carbon black reinforced rubber composition which contains little or no silica is simply not logical because it would normally be expected to lead to an excessively fast cure rate of the rubber composition which would be expected to be evidenced by scorching, or premature curing, of the rubber composition.

In such circumstance, it is necessary to add a sulfur cure retarder, such as for example, N-cyclohexylthiophthalimide, to the rubber composition to slow the sulfur cure rate of the rubber composition. Logic would seem to not have to add the sulfur cure retarder in a sense of more simply reducing the amount of secondary accelerator.

This amplifies the logic of the Applicant's aforesaid discovery.

The Applicants' discovery is believed to be even more dramatic in the sense that it was observed that a significant improvement in surface ozone resistance of a carbon black-reinforced conjugated diene-elastomer containing rubber composition can be obtained without the use of an increased amount of more conventional amine-based antiozonants which are relatively expensive and present rubber solubility issues and further, primarily because of their amine base, often lead to unwanted brown color staining of the ozone-exposed rubber component such as, for example, a tire sidewall.

In practice, sulfur vulcanized elastomer products are typically prepared by thermomechanically mixing rubber and various ingredients in a sequentially step-wise manner followed by shaping and curing the compounded rubber to form a vulcanized product.

First, for the aforesaid mixing of the rubber and various ingredients, typically exclusive of sulfur and sulfur vulcanization accelerators, the elastomer(s) and various rubber compounding ingredients are typically blended in one or more non-productive thermomechanical mixing stage(s) in suitable mixers. Such non-productive mixing is usually conducted at temperatures in a range of about 140° C. to 190° C. and often in a range of about 150° C. to 180° C.

Following such non-productive mixing stage, or stages, in a final mixing stage, sometimes referred to as a productive mix stage, sulfur and sulfur vulcanization accelerators (curatives), and sometimes optionally one or more additional ingredients, are mixed with the rubber compound, or composition, typically at a significantly lower temperature in a range of about 100° C. to about 120° C., which is a lower temperature than the temperatures utilized in the non-productive mix stages in order to prevent or retard premature curing of the sulfur curable rubber, which is sometimes referred to as scorching, of the rubber composition.

The rubber mixture, sometimes referred to as a rubber compound or composition, is typically allowed to cool, sometimes before or after intermediate mill mixing of the rubber composition, between the aforesaid various mixing steps, for example, to a temperature below 50° C.

Such sequential non-productive mixing steps, including the intermediary mill mixing steps and the concluding final productive mixing step are well known to those having skill in the rubber mixing art.

By thermomechanical mixing, it is meant that the rubber compound, or composition of rubber and rubber compounding ingredients, is mixed in a rubber mixer under high shear conditions where the mixture autogeneously heats up, with an accompanying temperature rise, as a result of the mixing primarily due to shear and associated friction within the rubber mixture in the rubber mixer.

For this invention, it is proposed to have at least one non-productive (NP) mixing stage, or step, usually in an internal rubber mixer, at an elevated temperature followed by a productive (PR) mixing stage at a lower temperature. Such rubber mixing procedure is well known to those having skill in such art.

As hereinbefore discussed, this invention is focused on the use of a primary sulfur cure accelerator (e.g. sulfenamide) in combination with a significant amount of aromatic guanidine (e.g. diphenyl guanidine) secondary accelerator together with an amine-based antiozonant with the aromatic guanidine being used in sufficient excessive amount to require a sulfur vulcanization retarder to reduce the sulfur cure rate of the carbon black reinforcement for a rubber composition containing at least one conjugated diene-based elastomer.

Also, as hereinbefore discussed, it is considered herein that such practice of the invention is a significant departure from past practices in that the carbon black-reinforced rubber composition, particularly for external, atmospherically exposed, tire components such as tire sidewalls in which the sidewall rubber composition is carbon black reinforced and contains conventional ingredients but in which an exceptionally high level, or content, of an aromatic guanidine secondary accelerator, such as for example diphenyl guanidine, is used which would ordinarily produce an excessively high rate of sulfur cure as would be evidenced by a rubber composition subject to early scorching, unless a sulfur cure retarder is used in the rubber composition to make the rubber composition useable in the production of the rubber composition, particularly for tire components.

In the description of this invention, the terms “rubber” and “elastomer” if used herein, may be used interchangeably, unless otherwise prescribed. The terms such as “rubber composition”, “compounded rubber” and “rubber compound”, if used herein, are used interchangeably to refer to rubber which has been blended or mixed with various ingredients and materials and “rubber compounding” or “compounding” may be used to refer to the mixing of such materials. Such terms are well known to those having skill in the rubber mixing or rubber compounding art.

The term “phr” relates to the parts by weight of an ingredient in a rubber composition per 100 parts by weight of the elastomer, or rubber. The terms “cure” and “vulcanize” may be used interchangeably unless otherwise indicated.

### SUMMARY AND PRACTICE OF THE INVENTION

In accordance with this invention a rubber composition is provided having a resistance to ozone-containing atmosphere degradation comprised of, based upon parts by weight per 100 parts by weight rubber (phr):

(A) at least one conjugated diene-based elastomer;

(B) particulate reinforcement in an amount of from about 10 to about 150 phr of:
(1) rubber reinforcing carbon black, or
(2) rubber reinforcing carbon black and up to about 10 phr, alternately up to 5 phr, of precipitated silica (synthetic silica);

(C) an antiozonant amount of a combination of:
(1) at least one amine-based antiozonant, (e.g. from about 0.5 to about 6 phr), and
(2) from about 0.5 to about 10, alternately from 1 to about 5, phr of an aromatic guanidine comprised of at least one of diphenyl guanidine and di-ortho-tolyl guanidine (preferably diphenyl guanidine),

(D) a primary sulfenamide primary sulfur cure accelerator (e.g. from about 0.5 to about 6 phr),

(E) a sulfur vulcanization retarder (e.g. from about 0.1 to about 1 phr thereof), and

(F) optionally a silica coupling agent for said precipitated silica, wherein said silica coupling agent contains a moiety reactive with hydroxyl groups (e.g. silanol groups) on said precipitated silica and another different moiety interactive with carbon-to-carbon bonds in said elastomer.

In practice, is usually desired that a weight ratio of said primary sulfur cure accelerator (e.g. sulfenamide) to said secondary sulfur cure aromatic guanidine accelerator is in a range of from about 1/1 to about 10/1.

Representative of such sulfenamide primary sulfur cure accelerators are, for example, cyclohexyl benzothiazole sulfenamide, tertiary butyl benzothiazole sulfenamide and dicyclohexyl benzothiazole sulfenamide.

Representative of such sulfur cure retarders is, for example, N-cyclohexylthiophthalimide.

In further accordance with this invention an article of manufacture is provided having at least one component comprised of such a rubber composition, particularly a sulfur cured rubber composition which is subject to atmospheric ozone exposure.

Such articles of manufacture may include industrial products and tires which contain rubber components which are subject to atmospheric ozone exposure.

Such industrial products may include, for example hoses, power transmission and conveyor belts, motor mounts and marine dock fenders.

In additional accordance with this invention, a tire is provided having at least one component comprised of such rubber composition, particularly a sulfur cured rubber composition, which is subject to atmospheric ozone exposure. Such tire component may be, for example, a tire sidewall.

In practice, various conjugated diene-based elastomers may be used for the rubber composition, representative of which are, for example, polymers comprised of at least one of 1,3-butadiene and isoprene and copolymers comprised of styrene with at least one of 1,3-butadiene and isoprene. Such elastomers are therefore sulfur curable elastomers.

Representative examples of such conjugated diene-based elastomers are, for example, cis 1,4-polyisoprene rubber (natural and/or synthetic), and preferably natural rubber, emulsion polymerization prepared styrene/butadiene copolymer rubber, organic solution polymerization prepared styrene/butadiene rubber, 3,4-polyisoprene rubber, isoprene/butadiene rubber, styrene/isoprene/butadiene terpolymer rubbers, cis 1,4-polybutadiene, medium vinyl polybutadiene rubber (35 to 50 percent vinyl content), high vinyl polybutadiene rubber (50 to 90 percent vinyl content), styrene/isoprene copolymers, emulsion polymerization prepared styrene/butadiene/acrylonitrile terpolymer rubber and butadiene/acrylonitrile copolymer rubber.

Other and additional conjugated diene-based elastomers include solution polymerization prepared high vinyl styrene/butadiene copolymer rubber (HV-S-SBR) having a bound styrene content in a range of about 5 to about 45 percent and a vinyl 1,2-content based upon its polybutadiene portion in a range of from about 30 to about 90 percent, particularly such (HV-S-SBR) having a relatively high onset high glass transition (Tg) value in a range of from about −20° C. to about −40° C. to promote a suitable wet traction for the tire tread and also a relatively high hot rebound value (100° C.) to promote a relatively low rolling resistance for the tread rubber composition intended for relatively heavy duty use. Such specialized high vinyl styrene/butadiene rubber (HV-S-SBR) might be prepared, for example, by polymerization in an organic solution of styrene and 1,3-butadiene monomers to include a chemical modification of polymer chain endings and to promote formation of vinyl 1,2-groups on the butadiene portion of the copolymer. A representative HV-S-SBR may be, for example, Duradene 738™ from Firestone/Bridgestone.

Other and additional conjugated diene-based elastomers are functionalized styrene/butadiene copolymer elastomers (functionalized SBR elastomers) containing amine and/or siloxy (e.g. alkoxyl silane as SiOR) functional groups.

Representative of such amine functionalized SBR elastomers is, for example, SLR4601™ from Dow Chemical and T5560™ from JSR, and in-chain amine functionalized SBR elastomers mentioned in U.S. Pat. Nos. 6,735,447 and 6,936,669.

Representative of such siloxy functionalized SBR elastomers is, for example, SLR4610™ from Dow Chemical.

Representative of such combination of amine and siloxy functionalized SBR elastomers is, for example, HPR350™ from JSR.

Other and additional conjugated diene-based elastomers are functionalized styrene/butadiene copolymer elastomers (functionalized SBR elastomers) containing hydroxy or epoxy functional groups.

Representative of such hydroxy functionalized SBR elastomers is, for example, Tufdene 3330™ from Asahi.

Representative of such epoxy functionalized SBR elastomers is, for example, Tufdene E50™ from Asahi.

In practice, it is therefore envisioned that said sulfur vulcanizable conjugated diene-based elastomer may be comprised of, for example, polymers of at least one of isoprene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers comprised of styrene and 1,3-butadiene (“functionalized SBR”) selected from amine functionalized SBR, siloxy functionalized SBR, combination of amine and siloxy functionalized SBR, epoxy functionalized SBR and hydroxy functionalized SBR.

The synthetic, amorphous silica (e.g. precipitated silica) if used, may, in general, be prepared by a controlled acidification of a soluble silicate, e.g., sodium silicate. Such precipitated silicas are well known to those having skill in such art.

Such precipitated silicas might have, for example, a BET surface area, as measured using nitrogen gas, preferably in the range of about 40 to about 600, and more usually in a range of about 50 to about 300 square meters per gram. A BET method of measuring surface area is described in the Journal of the American Chemical Society, Volume 60, understood to include Page 308 in the year 1938.

The silica may also have, for example, a dibutylphthalate (DBP) absorption value in a range of about 100 to about 350, and more usually about 150 to about 300 cc/100 gm.

Various commercially available silicas may be used, for example, only for example herein, and without limitation, silicas commercially available from PPG Industries under the Hi-Sil trademark with designations Hi-Sil 210, 243, etc; silicas available from Rhone-Poulenc, with, for example, designation of Zeosil 1165MP, silicas available from Degussa GmbH with, for example, designations VN2 and VN3, etc and silicas commercially available from Huber having, for example, a designation of Hubersil 8745.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins and plasticizers, fillers, pigments and waxes. As known to those skilled in the art, depending on the intended use of the sulfur vulcanizable and sulfur vulcanized material (rubbers), the additives mentioned above are selected and commonly used in conventional amounts.

Typical amounts of tackifier resins, if used, may comprise, for example, from about 1 to about 10 phr, for example, about 1 to about 5 phr. Typical amounts of processing aids may comprise, for example, about 1 to about 50 phr. Such processing aids can include, for example, aromatic, napthenic, and/or paraffinic processing oils. Typical amounts of waxes, if used, may comprise for example from about 1 to about 5 phr. Often microcrystalline waxes are used. Typical amounts of peptizers if used may comprise, for example, about 0.1 to about 1 phr. Typical peptizers may be, for example, pentachlorothiophenol and dibenzamidodiphenyl disulfide.

The invention may be better understood by reference to the following examples in which the parts and percentages are by weight unless otherwise indicated.

### EXAMPLE I (COMPARATIVE EXAMPLE)

Carbon black reinforced sulfur vulcanizable conjugated diene-based elastomer containing rubber compositions were prepared which contained rubber reinforcing carbon black and sulfur cure ingredients comprised of sulfur and sulfur cure accelerators.

The rubber Samples are identified herein as rubber Samples A, B and C.

Samples B and C contained an activated carbon (not normally considered as being a rubber reinforcing carbon black) for a purpose of determining its effect upon cured rubber properties, an aspect which is not considered herein as being a part of the invention.

The rubber Samples contained sulfur cure accelerators as cyclohexyl benzothiazole sulfenamide as a primary sulfur cure accelerator and a significantly smaller amount of diphenyl guanidine as a secondary, faster cure promoting sulfur cure accelerator in conventional amounts for a carbon black reinforced rubber composition of 0.47 and 0.09 phr, respectively.

The basic rubber composition formulation is presented in Table 1 and the ingredients are expressed in parts by weight per 100 parts rubber (phr) unless otherwise indicated.

The rubber compositions were prepared by mixing the elastomers(s) without sulfur and sulfur cure accelerators in a first non-productive mixing stage (NP-1) in an internal rubber mixer for about 4 minutes to a temperature of about 160° C. The resulting rubber mixture is then mixed in a productive mixing stage (PR) in an internal rubber mixer with sulfur and sulfur cure accelerator(s) for about 2 minutes to a temperature of about 110° C. The rubber composition is sheeted out and cooled to below 50° C. between each of the non-productive mixing steps and prior to the productive mixing step.

TABLE 1

| | Parts |
|---|---|
| Non-Productive Mixing (NP-1) | |
| Natural cis 1,4-polyisoprene rubber)¹ | 39 |
| Cis 1,4-polybutadiene rubber² | 61 |
| Carbon black³ | 46 and 41 |
| Amine based antioxidant/antiozonant⁴ | 4.3 |
| Rubber processing oil and tackifying resin⁵ | 17 |
| Microcrystalline and paraffinic wax blend | 1 |
| Fatty acid⁶ | 1.5 |
| Zinc oxide | 2 |
| Activated carbon⁷ | 0, 5 and 10 |
| Productive Mixing (PR) | |
| Sulfur | 1.9 |
| Primary sulfenamide sulfur cure accelator⁸ | 0.47 |
| Secondary diphenyl guanidine cure accelerator | 0.09 |

¹TSR20
²As BUD 1207 ™ from The Goodyear Tire & Rubber Company.
³N550, rubber reinforcing carbon black, an ASTM designation
⁴Blend of 3 phr of Santoflex 6PPD ™ amine based antiozonant from Flexys and 1.3 phr of Wingstay 100 ™ amine antioxidant from The Goodyear Tire & Rubber Company
⁵As Flexon 641 ™ from ExxonMobil and SP1068 ™ from SI Group
⁶Comprised of stearic acid and palmitic acid and a small amount of oleic acid
⁷From the MeadWestvaco Company
⁸Cyclohexyl benzothiazole sulfenamide primary sulfur cure accelerator

The following Table 2 illustrates cure behavior and various physical properties of rubber Samples A through C. Where a cured rubber sample was evaluated, such as for the stress-strain, rebound, hardness, tear strength and abrasion measurements, the rubber sample was cured for example, about 14 minutes at a temperature of about 160° C.

TABLE 2

| | Samples | | |
|---|---|---|---|
| | A | B | C |
| Rubber reinforcing carbon black (phr) | 46 | 41 | 41 |
| Activated carbon (phr) | 0 | 5 | 10 |
| Rheometer, 150° C. (MDR) | | | |
| Maximum torque (dNm) | 10.3 | 7.5 | 7.2 |
| Minimum torque (dNm) | 2 | 2.7 | 4.1 |
| Delta torque (dNm) | 8.3 | 4.8 | 3.1 |
| T₉₀, minutes | 10.8 | 25.6 | 48.5 |
| Stress-strain (ATS)¹ | | | |
| Tensile strength (MPa) | 14 | 6.5 | 5 |
| Elongation at break (%) | 767 | 625 | 509 |
| 300% modulus (MPa) | 3.5 | 2 | 2.4 |
| Rebound, 100° C. | 58 | 48 | 45 |
| Hardness (Shore A), 100° C. | 43 | 36 | 36 |
| Tear Strength², (Newtons) | 164 | 38 | 25 |
| Static Ozone Test Observations of Cured | | | |
| Rubber Samples, Ozone 50 pphm, | | | |
| 48 hours, 40° C., Variable Strain | | | |
| Number of cracks | D | D | D |
| Size of cracks | 2 | 4 | 4 |
| Dynamic ozone test observations of cured | | | |
| rubber Samples, Ozone 50 pphm, | | | |
| 48 hours, 40° C., 25% Strain | | | |
| Number of cracks | D | D | D |
| Size of cracks | 4 | 4 | 4 |

¹Data according to Automated Testing System instrument by the Instron Corporation which incorporates six tests in one system. Such instrument may determine ultimate tensile, ultimate elongation, modulii, etc.

The following is the key used to report visual observations of the cracks, if any, on the surface of a respective Sample.

| Number of Cracks | Size of Cracks |
|---|---|
| O = None | 1 = small (hairline cracks) |
| A = less than ¼ of the surface | 2 = medium |
| B = ¼ to ½ of the surface | 3 = large |
| C = ½ to ¾ of the surface | 4 = severe (open cracks) |
| D = ¾ to all of the surface | |

From Table 2 it can be seen that the addition of activated carbon (not rubber reinforcing carbon black) resulted in a drastically reduced cure rate of the rubber composition as evidenced by the T90 increasing from 10.8 to 25.6 and 48.5 minutes when using 5 and 10 phr, respectively, of the activated carbon.

From Table 2 it can further be seen that addition of the activated carbon tended to reduce the sulfur cure rate of the rubber composition, as evidenced by the increased T90 value, so that a higher level of the secondary accelerator, namely the diphenyl guanidine is required to increase the sulfur sure rate (reduce the T90 value).

### EXAMPLE II

Rubber reinforcing carbon black reinforced sulfur vulcanizable rubber mixtures were prepared which contained sulfur cure ingredients comprised of sulfur and sulfur cure accelerators.

The rubber Samples are identified herein as rubber Samples D, E, F and G.

The rubber Samples contained a primary sulfur cure accelerator as cyclohexyl benzothiazole sulfenamide in a conventional amount of 0.47 phr.

Rubber Sample D contained a secondary, faster sulfur cure promoting diphenyl guanidine in a conventional amount for a carbon black reinforced rubber composition in an amount of 0.09 phr.

However, rubber Samples E, F and G contained significantly greater contents of the diphenyl guanidine secondary accelerator in amounts of 1.2, 1.5 and 1.8 phr, respectively, to increase the cure rates of the rubber composition (reduce the T90 value).

The basic rubber composition formulation is presented in Table 3 and the ingredients are expressed in rounded values terms of weight, namely parts by weight per 100 parts rubber (phr) unless otherwise indicated.

The rubber compositions were prepared in the manner of Example I.

TABLE 3

| | Parts |
|---|---|
| Non-Productive Mixing (NP-1) | |
| Natural cis 1,4-polyisoprene rubber) | 39 |
| Cis 1,4-polybutadiene rubber | 61 |
| Carbon black | 50 |
| Antioxidant/antiozonant | 4.3 |
| Rubber processing oil and tackifying resin | 17 |
| Microcrystalline and paraffinic wax blend | 1 |
| Fatty acid | 1.5 |
| Zinc oxide | 2 |
| Activated carbon | 0, 0.5, 1 and 2 |
| Productive Mixing (PR) | |
| Sulfur | 1.9 |
| Primary sulfenamide sulfur cure accelerator | 0.47 |
| Secondary diphenyl guanidine cure accelerator | 0.09, 1.2, 1.5, and 1.8 |

The ingredients were those used in Example I

The following Table 4 illustrates cure behavior and various physical properties of rubber Samples D through G which contain various amounts of said sulfur cure accelerators.

TABLE 4

| | Samples | | | |
|---|---|---|---|---|
| | D | E | F | G |
| Diphenyl guanidine secondary accelerator | 0.09 | 1.2 | 1.5 | 1.8 |
| (phr) | | | | |
| Activated carbon (phr) | 0 | 0.5 | 1 | 2 |
| Rheometer, 150° C. (MDR) | | | | |
| Maximum torque (dNm) | 10.5 | 12.9 | 13.4 | 13.9 |
| Minimum torque (dNm) | 2.1 | 2.2 | 2.3 | 2.4 |
| Delta torque (dNm) | 8.4 | 10.7 | 11.1 | 11.5 |
| T₉₀, minutes | 13 | 5.7 | 5.7 | 6.1 |
| Stress-strain (ATS)¹ | | | | |
| Tensile strength (MPa) | 13.1 | 13.9 | 10.5 | 11.4 |
| Elongation at break (%) | 718 | 603 | 477 | 505 |
| 300% modulus (MPa) | 4 | 5.8 | 6.2 | 6.3 |
| Rebound, 100° C. | 60 | 67 | 67 | 66 |
| Hardness (Shore A), 100° C. | 45 | 50 | 48 | 50 |
| Tear Strength², Newtons (N) | 158 | 83 | 82 | 84 |
| Static Ozone Test Observations of Cured | | | | |
| Rubber Samples, Ozone 50 pphm, | | | | |
| 48 hours, 40° C., Variable Strain | | | | |
| Number of cracks | C | 0 | 0 | 0 |
| Size of cracks | 4 | 0 | 0 | 0 |
| Dynamic ozone test observations of cured | | | | |
| rubber Samples, Ozone 50 pphm, | | | | |
| 48 hours, 40° C., 60% Strain | | | | |
| Number of cracks | D | B | A | A |
| Size of cracks | 5 | 3 | 1 | 1 |

Visual observation ratings of number cracks and size of cracks, if any, were those used for Example I.

Tests for the rubber Samples were those used for Example I.

From Table 4 it can be seen that addition of higher levels of the diphenyl guanidine secondary accelerator resulted in increasing the cure rate to an excessively high cure rate (significantly reducing the T90 value) which will require an addition of a sulfur cure retarder to reduce the cure rate (increase the T90 value) to a reasonable cure rate to prevent pre-mature scorching of the rubber composition.

From Table 4 it can also be seen that the ozone resistance, including both the static and dynamic ozone resistance, was dramatically improved with the addition of the excessive amount of diphenyl guanidine secondary sulfur cure accelerator. Whether the activated carbon (not a rubber reinforcing carbon black) is required for this improved ozone resistance was not known from the results of this Example.

### EXAMPLE III

Carbon black reinforced sulfur vulcanizable rubber mixtures were prepared which contained rubber reinforcing carbon black and sulfur cure ingredients comprised of sulfur and sulfur cure accelerators.

The rubber Samples are identified herein as rubber Samples I, J, K, L, M and N.

The rubber Samples contained a significant amount of an amine-based antiozonant as 6PPD for a purpose of providing ozone resistance for the rubber composition.

The rubber Samples contained a primary sulfur cure accelerator as cyclohexyl benzothiazole sulfenamide in a conventional amount of 0.47 phr.

Rubber Samples I and L contained a secondary, faster sulfur cure promoting diphenyl guanidine in a conventional amount for a carbon black reinforced rubber composition in an amount of 0.1 phr.

However, rubber Samples J and K, as well as Samples M and N, contained greater amounts of the secondary, faster sulfur cure promoting diphenyl guanidine in amounts of 0.5 and 1.0 phr, as well in amounts of 0.5 and 1.0 phr, for the respective rubber Samples.

The basic rubber composition is presented in Table 5 and the ingredients are expressed in terms of parts by weight per 100 parts rubber (phr) unless otherwise indicated.

The rubber compositions were prepared in the manner of Example I.

TABLE 5

| | Parts |
|---|---|
| Non-Productive Mixing (NP-1) | |
| Natural cis 1,4-polyisoprene rubber) | 39 |
| Cis 1,4-polybutadiene rubber | 61 |
| Carbon black | 50 |
| Antioxidant⁸ | 1.3 |
| Rubber processing oil and tackifying resin | 17 |
| Microcrystalline and paraffinic wax blend | 1 |
| Fatty acid | 1.5 |
| Zinc oxide | 2 |
| Amine-based antiozonant⁹ | 4 and 3 |
| Productive Mixing (PR) | |
| Sulfur | 1.9 |
| Primary sulfenamide sulfur cure accelerator | 0.47 |
| Secondary diphenyl guanidine cure accelerator | 0.1, 0.5 and 1 |

⁸Antioxidant as Wingstay 100 ™ amine antioxidant from The Goodyear Tire & Rubber Company
⁹Antiozonant as Santoflex 6PPD ™ amine based antiozonant from Flexys

The other ingredients were the same as ingredients used for Example I.

The following Table 6 illustrates cure behavior and various physical properties of rubber Samples I through N which contain various amounts of said sulfur cure accelerators.

TABLE 6

| | Samples | | | | | |
|---|---|---|---|---|---|---|
| | I | J | K | L | M | N |
| Diphenyl guanidine secondary | 0.1 | 0.5 | 1 | 0.1 | 0.5 | 1 |
| accelerator (phr) | | | | | | |
| Amine based antiozonant | 4 | 4 | 4 | 3 | 3 | 3 |
| as 6PPD (phr) | | | | | | |
| Rheometer, 150° C. (MDR) | | | | | | |
| Maximum torque (dNm) | 10.6 | 12.4 | 14.1 | 10.9 | 12.3 | 13.4 |
| Minimum torque (dNm) | 2 | 2 | 2 | 2.1 | 2.1 | 2.2 |
| Delta torque (dNm) | 8.6 | 10.4 | 12.1 | 8.8 | 10.2 | 11.2 |
| T90, minutes | 12.7 | 7.6 | 6.9 | 13 | 7.5 | 5.7 |
| Stress-strain (ATS)¹ | | | | | | |
| Tensile strength (MPa) | 13.1 | 14.2 | 12.9 | 12.2 | 14.1 | 13.7 |
| Elongation at break (%) | 695 | 638 | 552 | 665 | 650 | 611 |
| 300% modulus (MPa) | 4.1 | 5.4 | 6.1 | 4.1 | 5.1 | 5.6 |
| Rebound, 100° C. | 58 | 64 | 68 | 58 | 63 | 65 |
| Hardness (Shore A), 100° C. | 44 | 48 | 50 | 44 | 47 | 50 |
| Tear Strength² (Newtons) | 157 | 91 | 60 | 161 | 99 | 82 |
| Static Ozone Test | | | | | | |
| Observations of | | | | | | |
| Cured Rubber Samples, | | | | | | |
| Ozone 50 pphm, | | | | | | |
| 48 hours, 40° C., | | | | | | |
| Variable Strain | | | | | | |
| Number of cracks | D | 0 | 0 | D | C | 0 |
| Size of cracks | 2 | 0 | 0 | 3 | 2 | 0 |
| Dynamic ozone test | | | | | | |
| observations of | | | | | | |
| cured rubber Samples, | | | | | | |
| Ozone 50 pphm, | | | | | | |
| 48 hours, 40° C., 60% Strain | | | | | | |
| Number of cracks | D | C | B | D | D | C |
| Size of cracks | 4 | 3 | 2 | 4 | 4 | 3 |

Visual observation ratings of number of cracks and size of cracks, if any, were those used for Example I.

Tests for the rubber Samples were those used for Example I.

From Table 6 it can be seen that increased amounts of the diphenyl guanidine secondary accelerator, whether with 3 or 4 phr of the amine-based antiozonant (6PPD) resulted in a significant improvement in both static and dynamic ozone resistance of the rubber composition.

From Table 6 it can also be seen that addition of 0.5 and 1.0 phr of the diphenyl guanidine secondary accelerator resulted in a fast curing rubber composition (low T90 value) which would lead to a too scorchy rubber composition which would not be satisfactorily useable for a tire component in a tire manufacturing process and would therefore require addition of a sulfur cure retarder to the rubber composition to reduce the cure rate (increase the T90 value).

### EXAMPLE IV

Carbon black reinforced sulfur vulcanizable rubber mixtures were prepared which contained rubber reinforcing carbon black and sulfur cure ingredients comprised of sulfur and sulfur cure accelerators.

A comparison of two aromatic guanidines, namely diphenyl guanidine and di-ortho-tolyl guanidine was evaluated for effectiveness of providing ozone resistance to sulfur curable rubber Samples.

The rubber Samples are identified herein as rubber Samples O, P, Q, R, and S.

Rubber Sample O was a Control rubber Sample which contained a sulfenamide primary sulfur cure accelerator (cyclohexyl benzothiazole sulfenamide) without a secondary aromatic guanidine.

Rubber Samples P and Q also contained 1 phr each of diphenyl guanidine and di-ortho-tolyl guanidine, respectively.

Rubber Samples R and S also contained 2 phr each of diphenyl guanidine and di-ortho-tolyl guanidine, respectively.

The basic rubber composition formulation is presented in Table 7 and the ingredients are expressed in terms of weight, namely parts by weight per 100 parts rubber (phr) unless otherwise indicated.

The rubber compositions were prepared in the manner of Example I.

TABLE 7

| | Parts |
|---|---|
| Non-Productive Mixing (NP-1) | |
| Natural cis 1,4-polyisoprene rubber) | 39 |
| Cis 1,4-polybutadiene rubber | 61 |
| Carbon black | 50 |
| Antioxidant | 1.3 |
| Rubber processing oil and tackifying resin | 17 |
| Microcrystalline and paraffinic wax blend | 1 |
| Fatty acid | 1.5 |
| Zinc oxide | 2 |
| Antiozonant | 3 |
| Productive Mixing (PR) | |
| Sulfur | 1.9 |
| Primary sulfonamide sulfur cure accelator⁸ | 0.5 |
| Secondary diphenyl guanidine cure accelerator | 0, 1 and 2 |
| Secondary di-ortho-tolyl guanidine accelerator | 0, 1 and 2 |
| Retarder (N-cyclohexylthiophthalimide) | 0, 0.25 and 0.5 |

Except for the indicated di-ortho-tolyl guanidine secondary accelerator, and the retarder, the ingredients were those used in Example III.

The following Table 8 illustrates cure behavior and various physical properties of rubber Samples O through S.

TABLE 8

| | Samples | | | | |
|---|---|---|---|---|---|
| | O | P | Q | R | S |
| Diphenyl guanidine | 0 | 1 | 0 | 2 | 0 |
| accelerator (phr) | | | | | |
| Di-o-tolyl guanidine | 0 | 0 | 1 | 0 | 2 |
| accelerator (phr) | | | | | |
| Retarder (phr) | 0 | 0.25 | 0.25 | 0.5 | 0.5 |
| Rheometer, 150° C. (MDR) | | | | | |
| Maximum torque (dNm) | 10.7 | 11.9 | 11.5 | 12 | 11.7 |
| Minimum torque (dNm) | 2.1 | 2.2 | 2.1 | 2.1 | 2 |
| Delta torque (dNm) | 8.6 | 9.7 | 9.4 | 9.9 | 9.7 |
| T90 minutes | 12 | 9 | 8.6 | 7.5 | 7.6 |
| Stress-strain (ATS)¹ | | | | | |
| Tensile strength (MPa) | 11.9 | 14 | 14 | 13.5 | 13.7 |
| Elongation at break (%) | 664 | 692 | 693 | 702 | 736 |
| 300% modulus (MPa) | 3.9 | 4.5 | 4.5 | 4.2 | 4 |
| Rebound, 100° C. | 59 | 61 | 60 | 58 | 58 |
| Hardness (Shore A), 100° C. | 43 | 46 | 45 | 45 | 44 |
| Tear Strength² (Newtons) | 139 | 142 | 138 | 166 | 162 |
| Static Ozone Test Observations | | | | | |
| of Cured Rubber Samples, | | | | | |
| Ozone 50 pphm, | | | | | |
| 48 hours, 40° C., Variable Strain | | | | | |
| Number of cracks | D | 0 | 0 | 0 | 0 |
| Size of cracks | 2 | 0 | 0 | 0 | 0 |
| Dynamic ozone test | | | | | |
| observations of cured | | | | | |
| rubber Samples, | | | | | |
| Ozone 50 pphm, | | | | | |
| 48 hours, 40° C., 60% Strain | | | | | |
| Number of cracks | D | D | C | C | B |
| Size of cracks | 4 | 4 | 3 | 3 | 2 |

Visual observation ratings of number cracks and size of cracks, if any, were those used for Example I.

Tests for the rubber Samples were those used for Example I.

From Table 8 it can be seen that the addition of diphenyl guanidine or di-ortho-tolyl guanidine at 1 phr (rubber Samples P and Q) resulted in significant improvement of static and dynamic ozone resistance when using the antiozonant at a constant level of 3 phr for the rubber Samples, including Control rubber Sample O.

It also appears that the di-ortho-guanidine provided slightly more improvement for dynamic ozone resistance.

It can further be seen that addition of the sulfur cure retarder resulted in providing T90 values (cure rates) approaching the Control rubber Sample O. It is considered herein that use of slightly greater amounts of the retarder should result in achieving the T90 values of the Control rubber Sample O.

### EXAMPLE V

This Example is provided to evaluate the effect of an inclusion of silica reinforcement.

Sulfur vulcanization rubber compositions were prepared which contained a combination of rubber reinforcing carbon black and precipitated silica reinforcement.

The rubber Samples are identified herein as Samples U, V and W.

Rubber Sample U is a Control rubber Sample which contained 30 phr of rubber reinforcing carbon black and 20 phr or precipitated silica in which sulfur and primary sulfenamide sulfur cure accelerator (cyclohexyl benzothiazole sulfenamide) were used.

Experimental Rubber Sample V was similar to Control rubber Sample U except that 1 phr of secondary aromatic guanidine sulfur cure accelerator as diphenyl guanidine was added together with a 0.1 phr of sulfur cure retarder.

Experimental Rubber Sample W was similar to rubber Sample V except that 2 phr of secondary aromatic guanidine sulfur cure accelerator as diphenyl guanidine was added together with a 0.25 phr of sulfur cure retarder.

The basic rubber composition formulation is presented in Table 9 and the ingredients are expressed in terms of weight, namely parts by weight per 100 parts rubber (phr) unless otherwise indicated.

The rubber compositions were prepared in the manner of Example I.

TABLE 9

| | Parts |
|---|---|
| Non-Productive Mixing (NP-1) | |
| Natural cis 1,4-polyisoprene rubber) | 39 |
| Cis 1,4-polybutadiene rubber | 61 |
| Carbon black³ | 30 |
| Precipitated silica¹⁰ | 20 |
| Silica coupling agent¹¹ | 2 |
| Antioxident | 1.3 |
| Rubber processing oil and tackifying resin | 17 |
| Microcrystalline and paraffinic wax blend | 1 |
| Fatty acid | 1.5 |
| Zinc oxide | 2 |
| Antiozonant | 3 |
| Productive Mixing (PR) | |
| Sulfur | 1.8 |
| Primary sulfonamide sulfur cure accelator⁸ | 1.2 |
| Secondary diphenyl guanidine cure accelerator | 0, 1 and 2 |
| Retarder (N-cyclohexylthiophthalimide) | 0, 0.1 and 0.25 |

¹⁰A precipitated silica as HiSil210 ™ from PPG
¹¹Silica coupler comprised of bis(3-triethoxysilylpropyl) polysulfide having an average in a range of from about 2.2 to about 2.4 connecting sulfur atoms in its polysulfide bridge.

Except for the silica and silica coupling agent, the ingredients were those used in Example IV.

The following Table 10 illustrates cure behavior and various physical properties of rubber Samples U, V and W.

TABLE 10

| | Samples | | |
|---|---|---|---|
| | U | V | W |
| Carbon black (phr) | 30 | 30 | 30 |
| Precipitated silica (phr) | 20 | 20 | 20 |
| Diphenyl guanidine accelerator (phr) | 0 | 1 | 2 |
| Retarder (phr) | 0 | 0.1 | 0.25 |
| Rheometer, 150° C. (MDR) | | | |
| Maximum torque (dNm) | 11.6 | 15.9 | 16.8 |
| Minimum torque (dNm) | 2.2 | 2.3 | 2.3 |
| Delta torque (dNm) | 9.4 | 13.7 | 14.5 |
| T90, minutes | 12.2 | 4.8 | 4.6 |
| Stress-strain (ATS)¹ | | | |
| Tensile strength (MPa) | 14.5 | 14.9 | 13.7 |
| Elongation at break (%) | 757 | 628 | 566 |
| 300% modulus (MPa) | 3.8 | 5.9 | 6.4 |
| Rebound, 100° C. | 69 | 71 | 70 |
| Hardness (Shore A), 100° C. | 56 | 58 | 59 |
| Tear Strength² (Newtons) | 180 | 78 | 69 |
| Static Ozone Test Observations of Cured | | | |
| Rubber Samples, Ozone 50 pphm, | | | |
| 48 hours, 40° C., Variable Strain | | | |
| Number of cracks | D | D | C |
| Size of cracks | 3 | 3 | 4 |
| Dynamic ozone test observations of cured | | | |
| rubber Samples, Ozone 50 pphm, | | | |
| 48 hours, 40° C., 60% Strain | | | |
| Number of cracks | D | D | D |
| Size of cracks | 4 | 4 | 4 |

Visual observation ratings of number cracks and size of cracks, if any, were those used for Example I.

Tests for the rubber Samples were those used for Example I.

From Table 10 it can be seen that the addition of 1 or 2 phr of an aromatic guanidine such as diphenyl guanidine to the rubber compositions containing both carbon black and precipitated silica reinforcement resulted in little or no improvement in both static and dynamic ozone resistance for the rubber compositions.

Accordingly, it is concluded that the presence of 20 phr of the precipitated silica negated the presence of the diphenyl guanidine secondary accelerator as to providing improved ozone resistance for the rubber composition. This notably relates to a surface phenomenon of silica which adsorbs the diphenyl guanidine and renders it unable to synergize with the amine antiozonant.

While certain representative embodiments and details have been shown for the purpose of illustrating the invention, it will be apparent to those skilled in this art that various changes and modifications may be made therein without departing from the spirit or scope of the invention.

What is claimed is:

1. A rubber composition comprised of, based upon parts by weight per 100 parts by weight rubber (phr):
(A) at least one conjugated diene-containing elastomer;
(B) particulate reinforcement in an amount of from about 10 to about 150 phr of:
(1) rubber reinforcing carbon black, or
(2) rubber reinforcing carbon black and up to about 10 phr of precipitated silica;
(C) an antiozonant amount of a combination of:
(1) from about 0.5 to about 6 phr of at least one amine-based antiozonant, and
(2) from about 0.5 to about 6 phr of aromatic guanidine comprised of at least one of diphenyl guanidine and di-ortho-tolyl guanidine,
(D) from about 0.5 to about 6 phr of a primary sulfonamide primary sulfur cure accelerator,
(E) about 0.1 to about 1 phr of a sulfur vulcanization retarder, and
(F) optionally a silica coupling agent for said precipitated silica, wherein said silica coupling agent contains a moiety reactive with hydroxyl groups (e.g. silanol groups) on said precipitated silica and another different moiety interactive with carbon-to-carbon bonds in said elastomer.

2. The rubber composition of claim 1 wherein the weight ratio of said primary sulfur cure accelerator to said secondary sulfur cure aromatic guanidine accelerator is in a range of from about 1/1 to about 10/1.

3. The rubber composition of claim 1 wherein said sulfenamide primary sulfur cure accelerator is comprised of at least one of cyclohexyl benzothiazole sulfenamide, tertiary butyl benzothiazole sulfenamide and dicyclohexyl benzothiazole sulfenamide.

4. The rubber composition of claim 1 wherein said sulfenamide primary sulfur cure accelerator is comprised of cyclohexyl benzothiazole sulfenamide.

5. The rubber composition of claim 1 wherein said sulfur cure retarder is comprised of N-cyclohexylthiophthalimide.

6. The rubber composition of claim 1 wherein said aromatic guanidine is comprised of diphenyl guanidine.

7. The rubber composition of claim 1 wherein said aromatic guanidine is comprised of di-ortho-tolyl guanidine.

8. The rubber composition of claim 1 wherein said particulate reinforcement is rubber reinforcing carbon black.

9. The rubber composition of claim 1 wherein said particulate reinforcement is rubber reinforcing carbon black and up to about 10 phr of precipitated silica.

10. The rubber composition of claim 1 wherein said particulate reinforcement is rubber reinforcing carbon black and up to about 5 phr of precipitated silica together with a coupling agent for the precipitated silica.

11. The rubber composition of claim 1 wherein:
(A) the weight ratio of said primary sulfur cure accelerator to said secondary sulfur cure aromatic guanidine accelerator is in a range of from about 1/1 to about 10/1;
(B) said sulfenamide primary sulfur cure accelerator is comprised of cyclohexyl benzothiazole sulfenamide;
(C) said sulfur cure retarder is comprised of N-cyclohexylthiophthalimide;
(D) said aromatic guanidine is comprised of diphenyl guanidine, and
(E) said particulate reinforcement is comprised of rubber reinforcing carbon black.

12. An article of manufacture having at least one component comprised of the sulfur cured rubber composition of claim 1.

13. The article of manufacture of claim 12 as an industrial product comprised of at least one of hoses, power transmission and conveyor belts, motor mounts and marine dock fenders.

14. An article of manufacture having at least one component comprised of the sulfur cured rubber composition of claim 11.

15. A tire having at least one component comprised of the sulfur cured rubber composition of claim 1.

16. A tire having at least one component comprised of the sulfur cured rubber composition of claim 11.

17. The tire of claim 15 wherein said component is at least one of a tire tread and a tire sidewall.

18. The tire of claim 16 wherein said component is at least one of a tire tread and a tire sidewall.

19. The rubber composition of claim 1 wherein said conjugated diene containing elastomer is at least one elastomer comprised of polymers of at least one of isoprene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers comprised of styrene and 1,3-butadiene (SBR) comprised of at least one amine functionalized SBR, siloxy functionalized SBR, combination of amine and siloxy functionalized SBR, epoxy functionalized SBR and hydroxy functionalized SBR.

20. The tire of claim 15 wherein said conjugated diene containing elastomer is at least one elastomer comprised of polymers of at least one of isoprene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers comprised of styrene and 1,3-butadiene (SBR) comprised of at least one amine functionalized SBR, siloxy functionalized SBR, combination of amine and siloxy functionalized SBR, epoxy functionalized SBR and hydroxy functionalized SBR.
